(19) United States
(12) Patent Application Publication
(10) Pub. No.: US 2024/0117646 A1
(43) Pub. Date: Apr. 11, 2024

(54) Concrete Pumping Pipe

(71) Applicant: Asahi Kasei Advance Corporation, Tokyo (JP)

(72) Inventors: Koichiro Sato, TOkyo (JP); Keiji Kasumi, Tokyo (JP)

(73) Assignee: Asahi Kasei Advance Corporation, Tokyo (JP)

(21) Appl. No.: 18/285,909

(22) PCT Filed: Apr. 12, 2021
(86) PCT No.: PCT/JP2021/015143

§ 371 Date: Oct. 6, 2023

(51) Int. Cl. E04G 21/04; F16L 9/127

(52) U.S. Cl. CPC E04G 21/04; F16L 9/127

(57) ABSTRACT

A concrete pumping pipe comprising no metal pipe, and having a cylindrical body composed of a resin, wherein a dynamic friction coefficient of the inner surface of the cylindrical body is 0.07 to 0.30, the cylindrical body is free of rupture and leakage in a 25 MPa hydraulic pressure resistance test, and a total luminous transmittance per 2 mm-thickness test piece of the cylindrical body is 10% or more.

### TECHNICAL FIELD

The present invention relates to a concrete pumping pipe.

### BACKGROUND ART

Fresh concrete before set and hardened (hereinafter, simply referred to as “concrete”) is a mixture of cement, water, fine aggregate, coarse aggregate, and an admixture optionally added, and has both property as a liquid and property as a solid. When pumping, fresh concrete forms a solid clog in a steel pipe and is pumped while causing friction against the pipe inner wall. At this time, the coarse aggregate is predominantly present in the center of the steel pipe, whereas water and a cement paste are predominantly present at the inner wall side of the steel pipe, and the pumping proceeds while water and the like present at the inner wall side buffer the frictional resistance caused during pumping. Pumping properties of concrete vary depending on the kind thereof. For example, highly viscose concrete such as with a small water amount has a high frictional resistance thereby leading to a clogged steel pipe, whereas concrete with a large amount of water is likely to separate solid from liquid thereby easily causing a clogged steel pipe and deteriorated quality of pumped concrete.

A steel pipe is generally used for pumping fresh concrete (for example, see Patent Literature 1). Steel pipes are optionally connected with joints and pump fresh concrete to any casting site. A steel pipe, which is a straight pipe, has a length of about 1, 2, or 3 m, and the higher pressure resistance performance of a steel pipe, the thicker and heavier the pipe wall. For example, in the case of a 3 m-steel pipe for high pressure, the pipe weighs about 65 kg. For this reason, several people are needed to handle a single steel pipe at a construction site.

### CITATION LIST

### Patent Literature

### Patent Literature 1

Japanese Patent Laid-Open No. 2019-085741

### SUMMARY OF INVENTION

### Technical Problem

Assuming such a steel pipe can be substituted with a resin pipe other than a metal pipe, preparation and the like of facilities for concrete pumping pipe at a construction site becomes easier, thereby enabling overall enhancement in work efficiency to be expected. However, it has been thought to be difficult for a concrete pumping pipe having no metal pipe to have a pressure resistance performance capable of pumping heavy fresh concrete, and to achieve a pumping pipe withstandable the wear during fresh concrete pumping.

Additionally, the conventional pumping method using a steel pipe has required to confirm how far fresh concrete has been pumped through in a steel pipe by sound changes when hitting the steel pipe, and the longer a pumping distance, the more workload for this confirmation operation has been needed. If conditions of a concrete pumping pipe can be confirmed more easily, early countermeasures for conditions such as clogging can be taken, thereby enabling casting work to be carried out more safely.

The present invention has been accomplished in view of the above problems, and aims to provide a concrete pumping pipe having no metal pipe, having excellent pumping performance, being lightweight, and excellent in safety.

### Solution to Problem

The present inventors conducted extended studies to solve the above problems. As a result, the present inventors have found that the concrete pumping pipe using a cylindrical body made of ultra high molecular weight polyethylene having predetermined properties can solve the above problems, whereby the present invention has been accomplished.

More specifically, the present invention is as follows.
[1]
   A concrete pumping pipe comprising
   no metal pipe, and
   having a cylindrical body composed of a resin,
   wherein a dynamic friction coefficient of the inner surface of the cylindrical body is 0.07 to 0.30,
   the cylindrical body is free of rupture and leakage in a 25 MPa hydraulic pressure resistance test, and
   a total luminous transmittance per 2 mm-thickness test piece of the cylindrical body is 10% or more.
[2]
   The concrete pumping pipe according to [1], wherein a contact angle of the inner surface of the cylindrical body is 55° or more.
[3]
   The concrete pumping pipe according to [1] or [2], wherein a wear amount of the inner surface of the cylindrical body by a sand slurry wear method is 10 mg or less.
[4]
   The concrete pumping pipe according to any one of [1] to [3], wherein a tensile breaking strength of the cylindrical body after an accelerated exposure test is carried out at a black panel temperature of 63° C.±3° C. for 1200 hours is 50% or more relative to a tensile breaking strength of 100% before the accelerated exposure test, and
   a tensile breaking elongation of the cylindrical body after the accelerated exposure test is carried out is 50% or more relative to a tensile breaking elongation of 100% before the accelerated exposure test.
[5]
   The concrete pumping pipe according to any one of [1] to [4], wherein a cylindrical body composed of a resin has a spiral male screw groove or a circumferential groove on an outer circumferential surface at both end parts.
[6]
   The concrete pumping pipe according to any one of [1] to [5], wherein the cylindrical body is a single layer pipe.
[7]
   The concrete pumping pipe according to any one of [1] to [6],
   wherein a maximum outer diameter R of the cylindrical body is 100 to 250 mm,
   an inner diameter r of the cylindrical body is 70 to 170 mm, and
   a thickness of the cylindrical body (R-r)/2 is 5 to 20 mm.
[8]
   The concrete pumping pipe according to any one of [1] to [7], wherein an overall length Lw of the cylindrical body is 0.3 to 4 m.
[9]
   The concrete pumping pipe according to [5], wherein a pitch of the male screw groove is 3 to 10 mm.
[10]
   The concrete pumping pipe according to any one of [1] to [9], wherein a ratio of a maximum outer diameter R′₂ of a flange formed between an end face of the cylindrical body and the circumferential groove to an inner diameter r of the cylindrical body R′₂/r is 1.05 to 1.4.
[11]
   The concrete pumping pipe according to any one of [1] to [10], wherein the resin contains an ultra high molecular weight polyethylene.
[12]
   The concrete pumping pipe according to [11], wherein a viscosity average molecular weight of the ultra high molecular weight polyethylene contained in the resin is 10×10⁴ or more and 1000×10⁴ or less.
[13]
   The concrete pumping pipe according to any one of [1] to [12],
   wherein the cylindrical body further contains an UV absorber, and
   a content of the UV absorber is 0.01 to 10 mass % relative to the total amount of the cylindrical body.
[14]
   A method for producing a concrete pumping pipe, comprising
   a molding step of screw extrusion molding a resin into a hollow cylindrical shape to produce the concrete pumping pipe according to any one of claims [1] to [13].

### Advantageous Effects of Invention

The present invention can accordingly provide a concrete pumping pipe having no metal pipe, having excellent pumping performance, being lightweight, and excellent in safety.

### BRIEF DESCRIPTION OF DRAWINGS

FIG. 1 shows a cross-section view cut along the center line of a cylinder of the concrete pumping pipe of the present embodiment.

FIG. 2 shows an image view of concrete inside visually recognizable when using the concrete pumping pipe of the present embodiment.

FIG. 3 shows a cross-section view of the state where the concrete pumping pipe of the present embodiment is connected.

FIG. 4 shows another cross-section view of the state where the concrete pumping pipe of the present embodiment is connected.

### DESCRIPTION OF EMBODIMENTS

Hereinafter, embodiment of the present invention (hereinafter, referred to as the “present embodiment”) will be described in detail, but the present invention is not limited thereto and can be in various modifications without departing from the scope of the invention.

### [Concrete Pumping Pipe]

The concrete pumping pipe of the present embodiment is a concrete pumping pipe having no metal pipe, and has a cylindrical body composed of a resin, wherein a dynamic friction coefficient of the inner surface of the cylindrical body is 0.07 to 0.15, the cylindrical body is free of rupture and leakage in a 25 MPa hydraulic pressure resistance test, and a total luminous transmittance per 2 mm-thickness test piece of the cylindrical body is 10% or more.

A metal pipe such as a steel pipe has been conventionally used for pumping concrete. This is presumably considered that a metal pipe is suitable for safe pumping because concrete to be pumped is heavy, and thus the pumping needs a reasonable pressure.

However, it has been revealed that a metal pipe is not necessarily appropriate for pumping concrete. For example, each one of metal pipes is heavy, requiring cautious handling by several workers to prevent any accidents from happening. For this reason, metal pipes pose problems in aspects of work safety and workload at a site.

Further, the dynamic friction coefficient between a metal pipe and concrete is comparatively high, and typically concrete is fed into the metal pipe using a preliminary material, but the amount of wasted preliminary material is large, and the workload that uses the preliminary material cannot be reduced, and the disposal cost on a large amount of the preliminary material cannot be reduced. In addition, a high dynamic friction coefficient causes concrete components to separate during pumping, and the concrete composition discharged from a pumping pipe outlet likely fluctuates. Such a fluctuation, when caused, greatly affects the strength and the like of a building, and thus the concrete with a fluctuated composition must be disposed, thereby causing the disposal cost to be enormous.

Further, the inside of a metal pipe cannot be visually recognized, and thus how far concrete has been transported through in a concrete pumping pipe cannot be confirmed, whereby it fails to notice that the concrete stuck in the middle of the concrete pumping pipe is causing clogging. When such a clogging occurs, accidents by rupture of a concrete pumping pipe occur, and moreover concrete pumping pipes arranged with workloads need to be disposed and rearranged, likely causing a significant work delay. Furthermore, the rupture of a metal pipe caused by clogging suddenly occurs at an unexpected location, thereby increasing risks during work.

On the other hand, the concrete pumping pipe of the present embodiment does not have a metal pipe such as the conventional steel pipe, but uses a resin cylindrical body having predetermined properties. The elimination of a metal pipe such as a steel pipe, unlike the concrete pumping pipe that is heavy and problematic in handleability, can achieve the concrete pumping pipe that is lightweight and can be safely handled at a work site.

Furthermore, the concrete pumping pipe of the present embodiment has a predetermined dynamic friction coefficient, thereby eliminating the need for use of a preliminary material. For this reason, the step of using a preliminary material itself can be reduced, and also the costs of using and disposing a preliminary material can be significantly reduced. Additionally, the separation of concrete components during pumping can be prevented, whereby the cost needed to dispose the concrete with a fluctuated composition can be significantly reduced.

In addition, in the present embodiment, the use of the cylindrical body composed of a resin enables the visual recognition of the content in the cylindrical body to be assured. This, even if concrete is stuck in the middle of a concrete pumping pipe, enables the clogging to be confirmed as soon as possible, thereby preventing a rupture accident. The resin cylindrical body, when an internal pressure increases, swells outward to the extent of being immediately visually noticeable before rupture. This enables workers at a site to immediately recognize a location at which rupture likely occurs, and appropriately evacuate. Hereinafter, the concrete pumping pipe of the present embodiment will be described in detail.

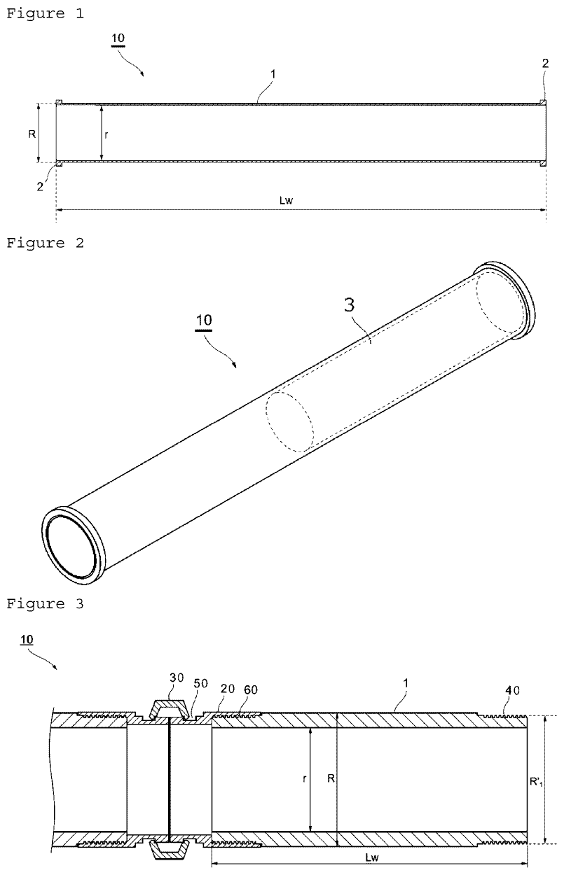

FIG. 1 shows a cross-section view cut along the center line of a cylinder of the concrete pumping pipe of the present embodiment. A concrete pumping pipe 10 has a cylindrical body 1 composed of a resin, and can have flanges 2 at both ends thereof for linking with joints. The concrete pumping pipe 10 of the present embodiment enables the visual recognition of the content (concrete 3) in the cylindrical body when using to be assured (FIG. 2).

### (Dynamic Friction Coefficient)

The dynamic friction coefficient of the inner surface of the cylindrical bode composed of a resin is 0.07 to 0.30, preferably 0.07 to 0.20, and more preferably 0.07 to 0.15. When a dynamic friction coefficient of the inner surface is within the above range, the use of a preliminary material is obviated, clogging less likely occurs, and the fluctuation in the composition of the concrete discharged can be more prevented. Particularly, in the inner surface of the cylindrical body composed of ultra high molecular weight polyethylene to be described later, it is preferable to carry out the screw extrusion molding to be described later for achieving a dynamic friction coefficient of 0.15 or less, which is the value extremely lower than the conventional value.

### (Hydraulic Pressure Resistance Test)

The cylindrical body composed of a resin is free of rupture and leakage in the 25 MPa hydraulic pressure resistance test. When a hydraulic pressure resistance performance is within the above range, there is no need to use a metal pipe even when pumping heavy concrete at a high pressure. In the present embodiment, “free of rupture and leakage in the 25 MPa hydraulic pressure resistance test” means that neither rupture nor leakage occurs. The “25 MPa hydraulic pressure resistance test” refers to the test by which tap water at room temperature is fed to the cylindrical body from a pressure pipe, pressure is applied to 25 MPa, and 2 minutes later, conditions of leakage and rupture occurrence are confirmed. Specific conditions are described in examples.

### (Total Luminous Transmittance)

The total luminous transmittance per 2 mm-thickness test piece of the cylindrical body is 10% or more, preferably 20 to 90%, more preferably 30 to 80%, and further preferably 40 to 70%. When a total luminous transmittance per 2 mm-thickness test piece of the cylindrical body is 10% or more, the visual recognition of a content tends to be more enhanced. When a total luminous transmittance per 2 mm-thickness test piece of the cylindrical body is 90% or less, mechanical strengths of the cylindrical body tend to be more enhanced.

### (Contact Angle)

The contact angle of the inner surface of the cylindrical body is preferably 55° or more, more preferably 60° to 90°, and further preferably 65° to 85°. When a contact angle of the inner surface of the cylindrical body is 55° or more, water components in concrete are easily repelled. In a metal pipe, water components attach to the inner surface of the metal pipe, likely causing different pumping rates between the center and the outer side in the pipe, and fluctuating the composition of concrete discharged. However, the cylindrical body of the present embodiment can prevent such a fluctuation, thereby obviating the use of a preliminary material, less likely causing clogging, and likely more preventing the fluctuation of concrete components discharged.

### (Wear Amount)

The wear amount of the inner surface of the cylindrical body by the sand slurry wear method to be described later is preferably 10 mg or less, more preferably 8.0 mg or less, further preferably 5.0 mg or less, and most preferably 2.0 mg or less. When a wear amount of the inner surface of the cylindrical body is 10 mg or less, wear resistance tends to be more enhanced. The lower limit in the wear amount of the inner surface of the cylindrical body is not particularly limited, and is 0 mg or more.

### (Tensile Breaking Strength)

The tensile breaking strength of the cylindrical body after an accelerated exposure test is carried out at a black panel temperature of 63° C.±3° C. for 1200 hours is preferably 50% or more, more preferably 75 to 150%, and further preferably 80 to 120% relative to a tensile breaking strength of 100% before the accelerated exposure test. When a tensile breaking strength of the cylindrical body after the accelerated exposure test is carried out is 50% or more, the weatherability of a concrete pumping pipe exposed to a high temperature under direct exposure to the sunlight tends to be more excellent.

### (Tensile Breaking Elongation)

Additionally, from the same viewpoint, the tensile breaking elongation of the cylindrical body after the above accelerated exposure test is carried out is preferably 50% or more, preferably 50% or more, more preferably 75 to 150%, and further preferably 80 to 120% relative to a tensile breaking elongation of 100% before the accelerated exposure test. When a tensile breaking elongation of the cylindrical body after the accelerated exposure test is carried out is 50% or more, the weatherability of a concrete pumping pipe exposed to a high temperature under direct exposure to the sunlight tends to be more excellent.

### (Resin Composition)

Examples of the resin composing the concrete pumping pipe include thermoplastic resins and thermosetting resins. To these resins, additives such as an UV absorber can be added.

The thermoplastic resin is not particularly limited, and examples include polyolefin resins, polyester resins, polyacrylate, liquid crystal polyester, polyvinyl chloride, polyvinyl alcohol, ethylene-vinyl acetate, polystyrene, acrylonitrile-butadiene-styrene copolymer resins, acrylonitrile-styrene copolymer resins, polymethyl methacrylate, polyamide resins, polyacetal, polycarbonate, fluorine resins, polyether ether ketone, polyethersulfone, and polyphenylene sulfide.

The thermosetting resin is not particularly limited, and examples include phenolic resins, urea resins, melamine resins, allyl reins, and epoxy resins.

Of these, thermoplastic resins are preferable from viewpoint of shapeability, secondary processability, and the like. Further, among the thermoplastic resins, polyolefin resins represented by polyethylene and polypropylene are preferable in view of low price, excellent chemical resistance, excellent processability, low moisture absorbency and water absorbency of materials.

The polyolefin resin is not particularly limited, and examples include ethylene homopolymers; copolymers of ethylene and one or more α-olefins such as propylene, butene-1, hexane-1, and octane-1; copolymers such as ethylene and vinyl acetate, acrylic acid, methacrylic acid, acrylate ester, or methacrylate ester; propylene homopolymers; and copolymers such as propylene and one or more α-olefins such as ethylene, and butene-1.

Of the polyolefin resins, polyethylene is the most preferable on the ground of low price, low friction coefficient, excellent processability after molded, excellent chemical resistance, and low moisture absorbency and water absorbency of material itself.

The density of polyethylene is preferably 890 to 970 kg/m³, more preferably 900 to 960 kg/m³, and further preferably 910 to 950 kg/m³. When a density is 890 kg/m³ or more, the stiffness of the cylindrical body tends to be more enhanced. When a density is 970 kg/m³ or less, the handleability tends to be more enhanced. The density of polyethylene herein can be measured and obtained by the density-gradient tube method (23° C.) in conformity with JIS K 7112:1999.

The viscosity average molecular weight of polyethylene is preferably 10×10⁴ to 1000×10⁴, more preferably 100×10⁴ to 1000×10⁴, and further preferably 300×10⁴ to 1000×10⁴. When a viscosity average molecular weight of polyethylene is within the above range, wear resistance is more enhanced, and a sufficient strength withstandable a high pumping pressure tends to be achieved. The polyethylene having the above viscosity average molecular weight is referred to as the “ultra high molecular weight polyethylene” in the present embodiment.

The viscosity average molecular weight can be determined by, for example, the following method. First, polyethylene is dissolved in decalin (decahydronaphthalene) to prepare several solutions having different concentrations. Reduced viscosity (ηsp/C) of these solutions are determined respectively in a constant temperature reservoir at 135° C. using an ubbelohde viscometer. A linear equation of reduced viscosity (ηsp/C) between concentration (C) and polymer is derived to determine limiting viscosity ([η]) extrapolated to density 0. The viscosity average molecular weight (Mv) can be determined using the following equation from this limiting viscosity ([η]).

Mv=5.34×10⁴×[η]^{1.49}

For the concrete pumping pipe, the raw material resin can be a mixed raw material of polyethylenes having different densities and/or viscosity average molecular weights, or can be a mixed raw material of polyethylene and a raw material resin other than the polyethylene.

Additionally, in the concrete pumping pipe of the present embodiment, various additives such as a heat stabilizer, an UV absorber, a coloring pigment, and a flame retarder can be added to the resin within the range in which the effects of the present embodiment are not affected.

### (UV Absorber)

The cylindrical body of the present embodiment can further contain, optionally, an UV absorber as an additive. The UV absorber is not particularly limited as long as a substance absorbs UV rays of wavelength regions harmful to the resin. Examples include benzophenone UV absorbers, benzotriazole UV absorbers, and cyanoacrylate UV absorbers.

The benzophenone UV absorber is not particularly limited, and examples include 2-hydroxy-4-octoxybenzophenone. The benzotriazole UV absorber is not particularly limited, and examples include 2-(2′-hydroxy-5′-methylphenyl)benzotriazole. The cyanoacrylate UV absorber is not particularly limited, and examples include 2-ethylhexyl-2-cyano-3,3′-diphenylacrylate. Of these, benzophenone UV absorbers are more preferable. When such an UV absorber is used, the weatherability tends to be more enhanced. In the present embodiment, the weatherability refers to the tolerance against deterioration in physical properties when the above accelerated exposure test is carried out.

The content of the UV absorber is preferably 0.01 to 10 mass %, more preferably 0.01 to 10 mass %, and further preferably 0.01 to 10 mass % relative to the total amount of the cylindrical body. When a content of the UV absorber is within the above range, the weatherability tends to be more enhanced.

### [External Form]

The cylindrical body of the present embodiment is composed of a resin pipe without having a metal pipe. Examples of the structure of the cylindrical body include a multilayer pipe composed of a resin pipe having multi-resin layers, a multilayer pipe having any inner layers to a pipe composed of a single-resin layer, and a single layer pipe composed of single-resin layer. Of these, the single layer pipe is preferable. There is an embodiment of wrapping a metal band around a part of the outer circumference of the cylindrical body composed of a resin pipe for the purpose of preventing rupture or as a handle when moving, but even such an embodiment applies to the resin concrete pumping pipe having no metal pipe of the present invention.

The outer diameter, inner diameter, and thickness of the cylindrical body are not particularly limited as long as these sizes are used for a conventional concrete pumping pipe. For example, the maximum outer diameter R is preferably 100 to 250 mm, more preferably 110 to 240 mm, and further preferably 120 to 230 mm. The inner diameter r of the cylindrical body is preferably 70 to 170 mm, more preferably 80 to 160 mm, and further preferably 90 to 150 mm. When such a cylindrical body is used, concrete containing solid contents of various sizes can be efficiently pumped in a comparatively large amount, whereby the pumping performance tends to be more enhanced.

Further, the thickness of the cylindrical body (R-r)/2 is preferably 5 to 20 mm, more preferably 7.5 to 17.5 mm, and further preferably 10 to 15 mm. When such a cylindrical body is used, the lifespan of the concrete pumping pipe tends to be longer.

The length of the cylindrical body is not particularly limited as long as the size is used for a conventional concrete pumping pipe. For example, the overall length Lw of the cylindrical body is preferably 0.3 to 4 m, more preferably 1.5 to 3.7 m, and further preferably 2.0 to 3.5 m.

FIG. 3 shows, as an example, a cross-section view of the state where the concrete pumping pipe of the present embodiment is connected. A concrete pumping pipe 10 has a cylindrical body 1 composed of a resin, and has spiral male screw grooves 40 at both ends thereof for linking using joints 30 via couplings 20. The coupling 20 herein has a circumferential groove 50 for engaging with the joint 30, and spiral female screw groove 60 for threadedly connecting to the spiral male screw groove 40 at both ends of the cylindrical body 1. When such a male screw groove 40 is provided and connected to the coupling 20, the joint 30 that has been conventionally used for a steel pipe can also be used. The coupling 20 and the joint 30 can be composed of either a resin or a metal. In FIG. 3, R′₁ shows the maximum outer diameter of the male screw groove 40 and is designed in such a way as to fit in the female screw groove 60 of the coupling 20.

The pitch of the male screw groove 40 herein is preferably 3 to 10 mm, more preferably 3 to 9 mm, and further preferably 3 to 8 mm. When a pitch of the male screw groove 40 is within the above range, the strength (pressure resistance) at the threadedly connected part of the coupling 20 and the cylindrical body 1 is enhanced, and liquid leakage at the threadedly connected part tends to be more prevented.

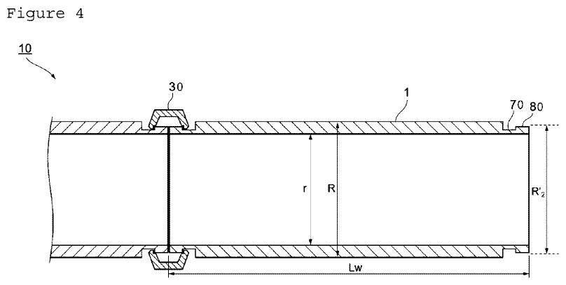

Further, FIG. 4 shows, as another example, a cross-section view of the state where the concrete pumping pipe of the present embodiment is connected. The concrete pumping pipe 10 in FIG. 4 has the cylindrical body 1 composed of a resin, and has a circumferential groove 70 at both ends thereof for linking using the joint 30. More specifically, the circumferential groove 70 forms a flange 80, and using this flange 80, the concrete pumping pipe 10 is linked using the joint 30. When such a circumferential groove 70 is provided, the joint 30 that has been used for a conventional steel pipe can also be used.

The ratio of the maximum outer diameter R′₂ of the flange 80 formed between an end face of the cylindrical body 1 and the circumferential groove 70 to the inner diameter r, R′₂/r, is preferably 1.05 to 1.4. When a ratio R′₂/r is within the above range, the mechanical strengths at both end parts of the cylindrical body 1 is enhanced, and breakage at the end part tends to be less likely occur.

The concrete pumping pipe 10 of the present embodiment uses a cylindrical body having at least an innermost layer and an outermost layer composed of a resin without having a metal pipe, thereby enabling the visual recognition of the content (concrete) in the cylindrical body when using to be assured.

The cylindrical body composed of a resin can be produced by a known method such as injection molding, and extrusion molding, and it can be molded into a solid cylindrical shape and then hollowed out inside, or can be molded into a hollow cylindrical shape. However, the above-described cylindrical body containing an UV absorber, and composed of ultra high molecular weight polyethylene having a viscosity average molecular weight of 10×10⁴ to 1000×10⁴, is preferably extrusion molded into a hollow shape, and particularly preferably the method by screw extrusion molding. This method enables to mold an ultra high molecular weight polyethylene resin, which is more difficult to be molded into a cylindrical shape than general resins, into a long cylindrical body having highly smooth inner circumferential surface.

### EXAMPLES

Hereinafter, the present invention will be more specifically described using examples and comparative examples. The present invention is not at all limited to the following examples.

### <Hydraulic Pressure Resistance Test>

Hydraulic pressure resistance of the concrete pumping pipes of Examples and the steel pipe of Comparative Example were confirmed in conformity with a high pressure test for a steel pipe. Specifically, a pumping pipe having a length of 1000 mm had both ends thereof closed with sealing plugs with a built-in pressure pipe and fixed to a sealing jig. Tap water at room temperature was fed to the pumping pipe from the pressure pipe, and a pressure was applied until the pressure from the apparatus reached 25 MPa, whereby conditions of leakage and rupture occurrence 5 minutes later were confirmed visually and by pressure measurement.

For the concrete pumping pipes of Examples, an apparatus pressure was further increased to 180 MPa, whereby conditions of leakage, swelling and rupture occurrence were confirmed 2 minutes later visually and by pressure measurement.

### <Dynamic Friction Coefficient>

The concrete pumping pipes of Examples and the steel pipe of Comparative Example were respectively cut to prepare test pieces having an outer diameter 25.6×inner diameter 20 mm×length 15 mm. The dynamic friction coefficient of the obtained test pieces was confirmed in conformity with JIS7218. Specifically, the dynamic friction coefficient was measured by the thrust wear method by causing friction against steel (S45C) under the conditions of a surface pressure of 0.83 kg/cm², and a linear velocity of 6.2 cm/sec.

### <Evaluation Method of Contact Angle>

The concrete pumping pipes of Examples and the steel pipe of Comparative Example were respectively cut to prepare 50×50 mm flat plates. The contact angle against water was measured by the static drop method. Specifically, the contact angle when 20 μl of water was dropped on the flat plate was microscopically observed, and the contact angle thereof was measured.

### <Evaluation Method of Wear Amount>

The concrete pumping pipes and the steel pipe of Examples of Comparative Example were respectively cut to prepare cuboid test pieces having a thickness of 4 mm, and 65 mm×30 mm. Subsequently, the wear amount was measured by the sand slurry wear method. More specifically, a sand slurry prepared by mixing an abrasive material to be used (Showa Denko K. K., WHITE MORUNDUM #20) and water in a ratio of 1:1 was put in a container, and 2 test pieces fixed vertically to a shaft were rotated like a stirrer blade while buried in 10 mm or more from the sand slurry surface. The rotation speed was 250 rpm. The weights of the respective test pieces were measured after 6×10⁴ rotations, and 18×10⁴ rotations, thereby defining the value obtained by subtracting the weight after 18×10⁴ rotations from the weight of the test piece after 6×10⁴ rotations as the wear amount. The average value of 3 test pieces measured was defined as the wear amount of the material.

For reference, the wear amounts of general materials are shown below.
Cast nylon: 5.6 mg
High-density polyethylene: 7.7 mg
Nylon 66: 8.3 mg
Polyurethane: 8.4 mg
Fluororesin: 9.0 mg
SUS: 9.8 mg
Polypropylene: 20.4 mg
Polyacetal: 24.0 mg
Bakelite: 27.8 mg
Brass: 45.0 mg
Low-density polyethylene: 48.2 mg

### <Evaluation Method of Total Luminous Transmittance>

The concrete pumping pipes of Examples and Comparative Example were cut to prepare test pieces having a thickness of 2 mm. Subsequently, the total luminous transmittance of test pieces was evaluated in conformity with JIS-K-7361 (Determination of the total luminous transmittance standard) and JIS-K-7136 (Determination of haze standard). Specifically, the total luminous transmittance (%) of both external haze and internal haze (unevenness was prevented with pure water in addition to a quartz cell) were measured using MURAKAMI COLOR RESEARCH LABORATORY HAZEMATER HM-150.

### <Method of Accelerated Exposure Test>

The concrete pumping pipes of Examples and Comparative Example were cut to prepare test pieces. The obtained test pieces were subjected to the sunshine carbon arc accelerated test, and the tensile breaking strength and tensile breaking elongation before and after the test were measured. Specifically, using Suga Test Instruments Co., Ltd. sunshine weather meter (sometimes referred to as weatherometer), a 1200-hr exposure test was carried out in conformity with JIS-B-7753 under the conditions a black panel temperature of 63° C. (±3° C.), a humidity of 50% (±5%), rain fall (120 min cycle; 102 min dry+18 min rain).

Using the test pieces of before and after the test, the tensile breaking strength and tensile breaking elongation were measured in conformity with JIS K 7127:1999 (Testing Method for Tensile Properties of Plastic) and JIS Z 2241:2011 (Test Method for Tensile Properties of Metallic Materials).

### <Method of Initial Pumping Test>

Three each of the concrete pumping pipes of Examples and Comparative Example were respectively connected to a concrete pump truck using joints, and the concrete pumping test was carried out under the conditions shown in Table 2. Plain concrete was used as the pumped concrete. Further, when a preliminary material was used, mortar was used as the preliminary material. The preliminary material was introduced in 1000 kg into the concrete pumping pipe prior to the concrete pumping, and discharged from the other end of the concrete pumping pipe, thereby being adhered to the inner surface of the concrete pumping pipe. When the concrete was supplied from the pump truck to the pumping pipe and pumped at an initial pressure of 1.5 MPa and a rate of 10 m³/h until 2 m³, the pumping condition was observed.

### <Pumping Condition>

The occurrence of clogging inside the pumping pipe by the time of having pumped 2 m³ of the concrete under the conditions shown in Table 2 was confirmed, and the pumping condition was evaluated. The condition of free of clogging was rated as “good”, whereas the condition of failing to complete the pumping due to clogging was rated as “clogged”.

<Visual Confirmation of Location where Concrete Passed Through>

In the pumping test, the location of the concrete inside was visually confirmed from the outside the concrete pumping pipe under the sunny weather, and the visual recognition was evaluated.

### <Evaluation Test on Estimated Casting Amount>

In continuation of the initial pumping test, the concrete was pumped to the total of 5000 m³ under the same conditions, and the following evaluation was carried out. It should be noted that when clogging was about to occur due to pumping over an extended period of time, the pressure was once increased to 25 MPa, and when the clogging was relieved, the condition was reverted to the original condition and the pumping was continued. When the clogging was not relived, the test was terminated at that time.

### <Liquid Leakage>

The occurrence of concrete liquid leakage from the joints, the connecting parts of the concrete pumping pipes, by the time of having pumped 5000 m³ of the concrete under the conditions shown in Table 2 was confirmed, and the occurrence of liquid leakage, or otherwise, was evaluated.

### <Properties of Concrete Discharged>

The fluctuation, or otherwise, in composition of the concrete to be discharged by the time of having pumped 5000 m³ of the concrete under the conditions shown in Table 2 was confirmed, and properties of the concrete discharged were evaluated.

### <Rupture Prediction⋅Body Swelling>

The occurrence of swelling at the body part of the concrete pumping pipe by the time of having pumped 5000 m³ of the concrete under the conditions shown in Table 2 was confirmed. When the occurrence of swelling was visually recognized, the pumping was continued and the pumped amount at which the swelled part ruptured was measured and defined as the “manageable amount for pumping after body swelling”.

### Example 1

An ultra high molecular weight polyethylene powder (Asahi Kasei Corporation, SUNFINE UH910) was molded into a hollow cylindrical shape by screw extrusion molding, thereby obtaining a cylindrical body having a length of 3 m. During this operation, 3000 ppm (0.3 mass %) of an UV absorber, 2-(2′-hydroxy-5′-methyphenyl)benzotriazole, was added to the polyethylene. Spiral male screw grooves shown in FIG. 3 were provided on the outer circumferential surface at both end parts of the obtained cylindrical body for allowing metal couplings to join. The pitch of male screw grooves was 5 mm. The obtained cylindrical body was used as a concrete pumping pipe.

### Example 2

A cylindrical body was molded in the same manner as in Example 1 in the exception that no UV absorber was contained, and used as a concrete pumping pipe.

### Example 3

A cylindrical body was molded in the same manner as in Example 1 in the exception that the circumferential grooves shown in FIG. 4 were formed on both end parts of the obtained cylindrical body for forming flanges to link with joints, and used as a concrete pumping pipe. The outer diameter of the groove part was 144 mm, the outer diameter R′₂ at the end part was 148 mm, and the R′₂/r was 1.113.

### Comparative Example 1

A commercial steel pipe (Linex Co., Ltd., product name Green Line) was used as a concrete pumping pipe of Comparative Example.

TABLE 1

| | | | | | Comparative |
|---|---|---|---|---|---|
| | | Example 1 | Example 2 | Example 3 | Example 1 |
| Material | | Ultra high molecular | Ultra high molecular | Ultra high molecular | Steel pipe |
| | | weight polyethylene | weight polyethylene | weight polyethylene | |
| End part | | FIG. 3 | FIG. 3 | FIG. 4 | — |
| Diameter R (mm) | | 165 | 165 | 165 | 139.8 |
| Inner diameter r (mm) | | 133 | 133 | 133 | 126.6 |
| Thickness (R − r)2 (mm) | | 16 | 16 | 16 | 6.6 |
| Pitch (mm) | | 5 | 5 | — | — |
| Length per pipe (m) | | 3 | 3 | 3 | 3 |
| Weight (Kg) | | 23.2 | 23.2 | 23.2 | 65 |
| 25 MPa hydraulic pressure | | Pass*¹ | Pass*¹ | Pass*¹ | Pass*¹ |
| resistance test result | | | | | |
| 180 MPa hydraulic pressure | | Pass*¹ | Pass*¹ | Pass*¹ | —*² |
| resistance test evaluation | | | | | |
| Dynamic friction coefficient | | 0.12 | 0.12 | 0.12 | 0.52 |
| Contact angle (°) | | 74 | 74 | 74 | 50 |
| Transmittance (%) | | 52.4 | 52.4 | 52.4 | 0 |
| Wear amount (mg) | | 1.5 | 1.5 | 1.5 | 11.7 |
| Accelerated | Tensile breaking | 403 | 403 | 403 | Not measured |
| exposure | strength 0 hours | | | | |
| test | Tensile breaking | 405 | 209 | 405 | |
| | strength 200 hours | | | | |
| | Tensile breaking | 320 | 320 | 320 | |
| | elongation 0 hours | | | | |
| | Tensile breaking | 360 | 20 | 360 | |
| | elongation 200 hours | | | | |

*¹Pass: No rupture or leakage occurs.
*²Evaluation not possible due to extremely high risk of rupture.

TABLE 2

| Pumping test | Example 1 | | Example 2 | Example 3 | Comparative Example 1 | |
|---|---|---|---|---|---|---|
| Preliminary material | Yes | No | Yes | No | Yes | No |
| Length (m) | 9 | 9 | 9 | 9 | 9 | 9 |
| Pressure (MPa) | 1.5 | 1.5 | 1.5 | 1.5 | 1.5 | 1.5 |
| Rate (m³/h) | 10 | 10 | 10 | 10 | 10 | 10 |
| Amount pumped (m³) | 2 | 2 | 2 | 2 | 2 | 1 |
| Amount of waste material*³ (Kg) | 1000 | 0 | 1000 | 0 | 1000 | 0 |
| Pumping condition | Good | Good | Good | Good | Good | Clogged |
| Visual confirmation of location where | Possible | Possible | Possible | Possible | Not possible | Not possible |
| concrete passed through | | | | | | |
| Liquid leakage | No | No | No | No | No | No |
| Properties of concrete discharged | Good | Good | Good | Good | Fluctuated | Fluctuated |
| Rupture prediction • body swelling *⁴ | Yes | Yes | Occurred at | Yes | No | No |
| (Manageable amount for pumping after body | | | 4990 m³ (10 m³) | | | |
| swelling) | | | | | | |

*³Amount of waste material: Amount of waste material of preliminary material used prior to pumping concrete
*⁴ In case “Yes”, rupture can be predicted in advance and workers can evacuate from a site. On the other hand, in case “No”, rupture cannot be predicted and workers are at a risk.

### INDUSTRIAL APPLICABILITY

The concrete pumping pipe of the present invention has industrial applicability at a site where concrete is pumped.

### REFERENCE SIGNS LIST

1 . . . Cylindrical body, 2 . . . Flange, 10 . . . Concrete pumping pipe, 20 . . . Coupling, 30 . . . Joint, 40 . . . Male screw groove, 50 . . . Circumferential groove, 60 . . . Female screw groove, 70 . . . Circumferential groove, 80 . . . Flange

1: A concrete pumping pipe comprising
no metal pipe, and
having a cylindrical body composed of a resin,
wherein a dynamic friction coefficient of the inner surface of the cylindrical body is 0.07 to 0.30,
the cylindrical body is free of rupture and leakage in a 25 MPa hydraulic pressure resistance test, and
a total luminous transmittance per 2 mm-thickness test piece of the cylindrical body is 10% or more.

2: The concrete pumping pipe according to claim 1, wherein a contact angle of the inner surface of the cylindrical body is 550 or more.

3: The concrete pumping pipe according to claim 1, wherein a wear amount of the inner surface of the cylindrical body by a sand slurry wear method is 10 mg or less.

4: The concrete pumping pipe according to claim 1, wherein a tensile breaking strength of the cylindrical body after an accelerated exposure test is carried out at a black panel temperature of 63° C.±3° C. for 1200 hours is 50% or more relative to a tensile breaking strength of 100% before the accelerated exposure test, and
a tensile breaking elongation of the cylindrical body after the accelerated exposure test is carried out is 50% or more relative to a tensile breaking elongation of 100% before the accelerated exposure test.

5: The concrete pumping pipe according to claim 1, wherein a cylindrical body having at least an innermost layer and an outermost layer composed of a resin has a spiral male screw groove or a circumferential groove on an outer circumferential surface at both end parts.

6: The concrete pumping pipe according to claim 1, wherein the cylindrical body is a single layer pipe.

7: The concrete pumping pipe according to claim 1,
wherein a maximum outer diameter R of the cylindrical body is 100 to 250 mm,
an inner diameter r of the cylindrical body is 70 to 170 mm, and
a thickness of the cylindrical body (R−r)/2 is 5 to 20 mm.

8: The concrete pumping pipe according to claim 1, wherein an overall length Lw of the cylindrical body is 0.3 to 4 m.

9: The concrete pumping pipe according to claim 5, wherein a pitch of the male screw groove is 3 to 10 mm.

10: The concrete pumping pipe according to claim 5, wherein a ratio of a maximum outer diameter R′₂ of a flange formed between an end face of the cylindrical body and the circumferential groove to an inner diameter r of the cylindrical body R′₂/r is 1.05 to 1.4.

11: The concrete pumping pipe according to claim 1, wherein the resin contains an ultra high molecular weight polyethylene.

12: The concrete pumping pipe according to claim 11, wherein a viscosity average molecular weight of the ultra high molecular weight polyethylene contained in the resin is 10×10⁴ or more and 1000×10⁴ or less.

13: The concrete pumping pipe according to claim 1,
wherein the cylindrical body further contains an UV absorber, and
a content of the UV absorber is 0.01 to 10 mass % relative to the total amount of the cylindrical body.

14: A method for producing a concrete pumping pipe, comprising
a molding step of screw extrusion molding a resin into a hollow cylindrical shape to produce the concrete pumping pipe according to claim 1.
